(19) United States
(12) Patent Application Publication
(10) Pub. No.: US 2003/0167286 A1
(43) Pub. Date: Sep. 4, 2003

(54) Information processing apparatus

(76) Inventor: Akira Yasuta, Nara (JP)

Correspondence Address: NIXON & VANDERHYE, PC, 1100 N GLEBE ROAD, 8TH FLOOR, ARLINGTON, VA, 22201-4714, US

(21) Appl. No.: 10/364,524

(22) Filed: Feb. 12, 2003

(30) Foreign Application Priority Data
Mar. 1, 2002 (JP) 2002-56136

(51) Int. Cl. G06F 17/30; G06F 12/00; G06F 9/44

(52) U.S. Cl. 707/201

(57) ABSTRACT

An information processing apparatus allows the user to easily grasp which data has been updated by synchronization of data between the information processing apparatus and a different information processing apparatus, the apparatuses running a plurality of different applications. The information processing apparatus of the invention comprises means for attaching an identification marker to data that has been updated by an data-update involving process, means for storing data items including the updated data having the identification marker, and means for retrieving the updated data based on the identification marker.

### BACKGROUND OF THE INVENTION

1. Technical Field

The present invention relates to techniques for synchronizing data among a plurality of information devices. Particularly, it relates to an information processing technique for synchronizing various types of data transferred from a personal computer (PC), such as email data and other data in PIM (personal information manager) or PDA (personal digital assistant) software such as a schedule chart or an address book, and displaying the synchronized data on a mobile terminal.

2. Background Art

It is now common to receive email and manage PIM information for a schedule or address book, for example, on a PC. At the same time, many people transfer email data or PIM information from a PC to a mobile terminal, which they can carry around.

PIM information may be modified on or added to a PC and/or a mobile terminal. In order to bring the information on both devices up to date, a synchronizing process is performed. Generally, information is updated on the PC, where data entry is easier, and then the data is transferred from the PC to the mobile terminal through the synchronizing process. The user can carry the mobile terminal around and view the transferred data on the terminal.

JP Patent Publication (Unexamined Application) No. 9-223060 discloses a technique for automatically synchronizing data between a PC and a mobile terminal. JP Patent Publication (Unexamined Application) No. 2000-137687 discloses a technique for displaying data such that the data before and after modification by a synchronizing process can be recognized. JP Patent Publication (Unexamined Application) No. 8-190569 discloses a technique for displaying a list of new arrivals in the information stored in a plurality of information storage units.

The technique known from JP Patent Publication (Unexamined Application) No. 9-223060 has the problem that, when the synchronizing process is performed to synchronize data between the PC and the mobile terminal, it is difficult to recognize which portions of the data on the mobile terminal have been updated.

The technique known from JP Patent Publication (Unexamined Application) No. 2000-137687 enables the user to determine what data has been updated. But in this technique, the updated data can be recognized only when it is displayed together with the non-updated data, and it is still difficult to identify the data that has been updated.

Further, while the technique according to JP Patent Publication (Unexamined Application) No. 8-190569 displays a list of updated data items, the list shows only that updated data that is of the same data format, and it cannot show data of different formats, such as email data or other items of PIM information.

### SUMMARY OF THE INVENTION

It is therefore an object of the present invention to provide a technique for displaying new arrival information which makes it possible to easily grasp what data has been updated. Specifically, after performing the data synchronizing process between a PC and a mobile terminal, the technique displays a list of files of data of different formats, such as email data and PIM information for a schedule or address book, that have been updated during the synchronizing process.

In one aspect, the invention provides an information processing apparatus capable of operating a plurality of applications, comprising:

means for attaching an identification marker to an item of data in multiple applications that has been updated by a process;

means for storing data items including the data item having the identification marker; and

means for retrieving the updated data from the data items based on the identification marker.

By using this information processing apparatus, data that has been updated by an update-involving process can be identified and retrieved across a plurality of applications.

In another aspect, the invention provides a first information processing apparatus comprising means for displaying a plurality of different items of data for a plurality of applications, the apparatus further comprising:

means for attaching identifying information to an item of data in the data for the multiple applications in the first information processing apparatus that has been updated by a synchronizing process between the first information processing apparatus and a second information processing apparatus;

means for storing items of data including the updated data having the identifying information; and

means for retrieving the updated data from the items of data based on the identifying marker.

In another aspect, the invention provides a first information processing apparatus comprising means for displaying a plurality of different items of data for a plurality of applications, the apparatus further comprising:

means for storing first information about the date/time when a data item in the multiple applications on the first information processing apparatus has been updated by a synchronizing process between the first information processing apparatus and a second information processing apparatus, in association with the updated data item;

means for storing second information about the history of synchronization, whereby the date/time is recorded each time a synchronizing process is performed;

means for comparing the first and second date/time; and

means for retrieving an item of data stored in the memory means that is associated with the first date/time which corresponds to the second date/time.

By using this information processing apparatus, it can be possible to retrieve the updated data before and after the synchronizing process, and retroeve the data over multiple applications.

In a further aspect, the invention provides a data structure comprising identification information for identifying data that has been updated by a synchronizing process between information processing apparatuses, the structure further comprising a data region common to multiple applications.

The common data region allows updated data to be retrieved based on the application-independent identification information, even when there are data for different applications.

### BRIEF DESCRIPTION OF THE DRAWINGS

FIG. 1 shows a functional block diagram of a mobile terminal having the new arrival information display function according to the invention.

FIG. 2 shows a conceptual system configuration of the mobile terminal having the new arrival information display function according to the invention, and a PC.

FIG. 3 shows an example of the data structure of an email application running on a mobile terminal having the new arrival information display function according to the first embodiment.

FIG. 4 shows an example of the data structure of a schedule application running on a mobile terminal having the new arrival information display function according to the first embodiment.

FIG. 5 shows an example of the data structure of a to-do list application running on a mobile terminal having the new arrival information display function according to the first embodiment.

FIG. 6 shows an example of the data structure of an address book application running on a mobile terminal having the new arrival information display function according to the first embodiment.

FIG. 7 shows an example of the data structure of a memo book application running on a mobile terminal having the new arrival information display function according to the first embodiment.

FIG. 8 shows an example of a new arrival list displayed on the screen of a mobile terminal having the new arrival information display function according to the first embodiment.

FIG. 9 shows an example of detailed information displayed on the screen of a mobile terminal having the new arrival information display function according to the first embodiment.

FIG. 10 shows a flowchart of the synchronizing process performed by the new arrival information display function according to the first embodiment.

FIG. 11 shows a flowchart of the process of clearing a new arrival flag of all of the data during the synchronizing process that is performed by the new arrival information display function according to the first embodiment.

FIG. 12 shows another flowchart of the synchronizing process performed by the new arrival information display function according to the first embodiment.

FIG. 13 shows a flowchart of the new-data synchronizing process performed by the new arrival information display function according to the first embodiment.

FIG. 14 shows the first half of a flowchart of the modified-data synchronizing process performed by the new arrival information display function according to the first embodiment.

FIG. 15 shows the latter half of the flowchart of the modified-data synchronizing process of FIG. 14 performed by the new arrival information display function according to the first embodiment.

FIG. 16 shows a flowchart of the deleted-data synchronizing process performed by the new arrival information display function according to the first embodiment.

FIG. 17 shows a flowchart of the process of creating a new arrival list during the synchronizing process performed by the new arrival information display function according to the first embodiment.

FIG. 18 shows an example of the data structure of an email application running on a mobile terminal having the new arrival information display function according to a second embodiment of the invention.

FIG. 19 shows an example of the data structure of a schedule application running on a mobile terminal having the new arrival information display function according to the second embodiment.

FIG. 20 shows an example of the data structure of a to-do list application running on a mobile terminal having the new arrival information display function according to the second embodiment.

FIG. 21 shows an example of the data structure of an address book application running on a mobile terminal having the new arrival information display function according to the second embodiment.

FIG. 22 shows an example of the data structure of a memo book application running on a mobile terminal having the new arrival information display function according to the second embodiment.

FIG. 23 shows an example of the data structure of synchronization history information on a mobile terminal having the new arrival information display function according to the second embodiment.

FIG. 24 shows an example of the data structure of history information stored on a new arrival information display function according to the second embodiment.

FIG. 25 shows a flowchart of the process of creating a new arrival list on a mobile terminal having the new arrival information display function according to the second embodiment.

### DESCRIPTION OF THE INVENTION

In the following description of preferred embodiments, the modification, deletion, or addition of data caused by the synchronizing process may be generally referred to as a data updating process.

Before describing the embodiments, the concept of the invention will be briefly discussed below.

The inventors initially conceived the idea of incorporating a new arrival flag in the data structure of each of the applications for various data such as email data and PIM information, which could be commonly recognized by the different applications.

Prior to the synchronizing process, new arrival flags are all cleared. When the synchronizing process is performed, a new arrival flag is set for data that has been newly added or modified. When it is necessary to display a list of new arrivals, all of the data is searched for that data for which a new arrival flag is set, and only the retrieved data is displayed in a list.

There are two methods of attaching a new arrival flag to a field. In one method, a new arrival flag region having common rules is added in a region in the data structure, such as a normal data region, which the application software developer can freely design. It should be noted that, in light of the synchronizing processing between a PC and a PDA the data structure needs to be adapted only on the PDA side, and therefore only the developer of PDA application software needs to make the data structure of his or her software compatible.

The second method provides a new arrival field in a region for the date/time, attribute information or the like, where each item of data is managed by an operating system (OS) such as Windows OS™ or MS-DOS. This second method can attach new arrival information across different application software items. As the attribute information in the data structure contains information about data size, for example, which is managed by the OS for each item of data, it is easy to attach an identification marker to the attribute information.

In both first and second methods, it is only necessary to add a new flag field in the data structure on the PDA.

For example, by providing the data structure of each application with a date/time memory function, it becomes possible to update the date/time of newly added or modified data with the date/time when a synchronized process was carried out. At the same time, the date/time information concerning the synchronizing process may also be stored in the system. When a list of new arrivals is displayed, the date/time of history information may be compared with the synchronization date/time for each item of data, so as to show only corresponding data.

Thus, a list of only those items of data that have been updated in a plurality of different applications can be displayed.

In the following, a first embodiment of the invention will be described by referring to the drawings.

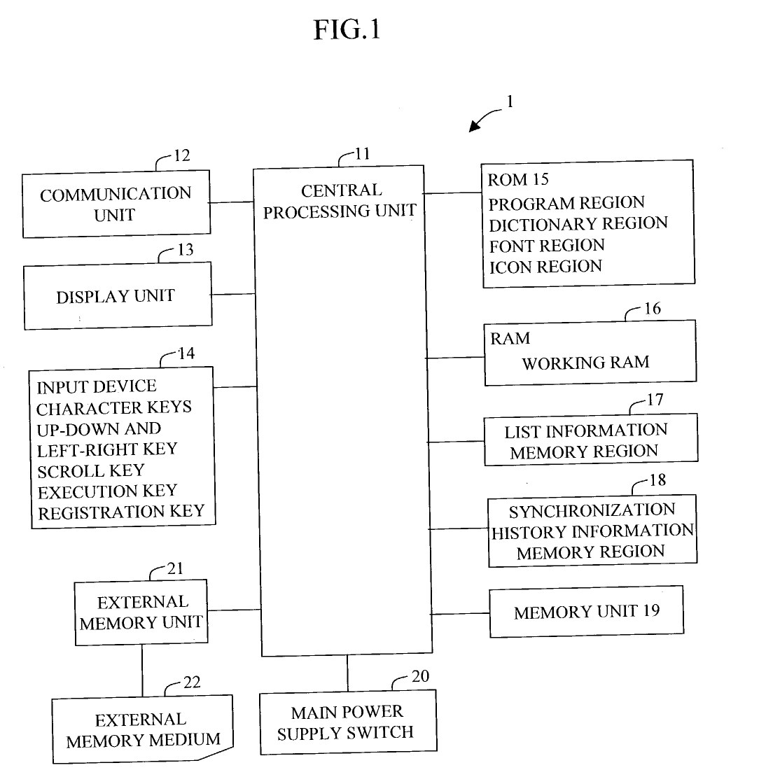

FIG. 1 shows a block diagram of a mobile terminal adapted for the new arrival information display technique according to the first embodiment of the invention.

A mobile terminal 1 comprises a central processing unit 11, a communication unit 12, a display unit 13, an input unit 14, a read only memory (ROM) 15, a random access memory (RAM) 16, a list information memory region 17, a synchronization history information memory region 18, a memory unit 19, a power supply switch 20, an external memory unit 21, and an external memory medium 22.

The central control unit 11 controls input or output information based on a variety of instructions. The communication unit 12 connects to a PC to transfer received mail or PIM information from the PC to the mobile terminal 1.

The display unit 13 displays the data in the mobile terminal 1 according to instructions from the central control unit 11. The input unit 14 includes character keys for entering letters and characters, an execute key for deciding on a selected content, and cursor keys for scrolling up and down the screen as well as for shifting a cursor or a selected item.

The central control unit 11 performs a variety of processes for generating data, selection, registration, and switching of windows in response to an input from the input device 14. ROM 15 includes a program area for storing a program for operating the central control unit 11, a dictionary area for storing a dictionary for character conversion, and a font and an icon area for displaying letters and characters on the screen. RAM 16 is a working RAM for data storage.

The list information memory region 17 stores information that is displayed when a new arrival list is displayed on the screen. The synchronization history information memory region 18 stores the date/time of execution of a synchronizing process. The memory unit 19 stores data concerning email, for example. The power supply switch 20 turns the main power supply on or off.

The external memory medium 22 is a memory medium separable from the mobile terminal 1, such as a floppy disc, a CD-ROM, or an IC card. It may also store a window-switching program for enabling the mobile terminal 1 to switch windows while maintaining the displays of the contents of email and an attached file, for example. By so doing, the window switching program stored in the external memory medium 22 can be read by the external memory unit 21 and then transferred to RAM 16, for example, thus making it possible to realize the window-switching function of the invention.

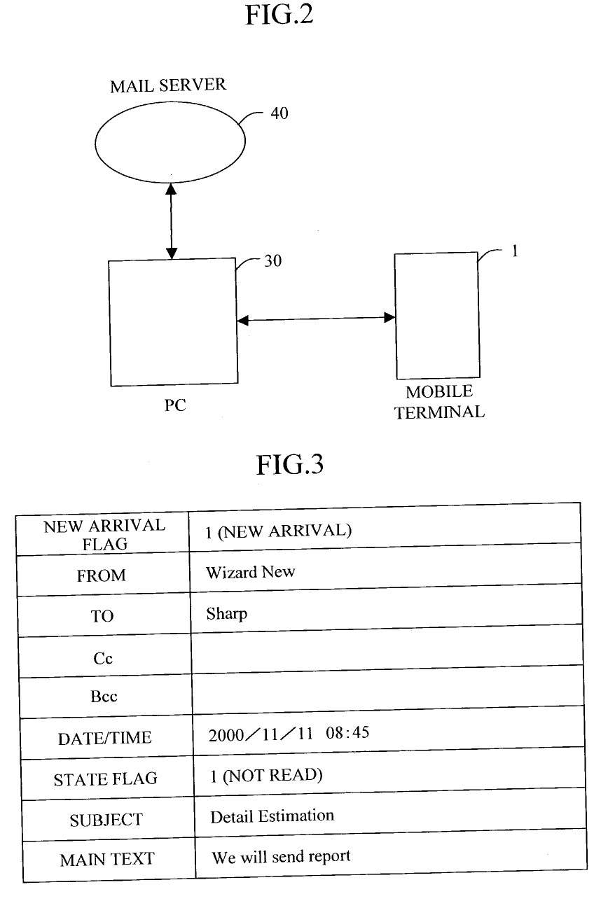

FIG. 2 schematically illustrates a system for performing the synchronizing process for synchronizing information between a PC 30 and the mobile terminal 1. The PC 30 can communicate with a mail server 40 to exchange email. It can also manage PIM information such as a schedule or an address book.

The mobile terminal 1 is connected to the PC 30 via the communication unit 12 so that they can transfer email and PIM information between them.

In the synchronizing process, data that has been newly added to the PC 30 is transferred to the mobile terminal 1, while newly registered data on the mobile terminal 1 is transferred to the PC 30. Then, data that has been modified on the PC 30 is written over the corresponding data on the mobile terminal 1, and data modified on the mobile terminal 1 is written over the corresponding data on the PC 30. When data is modified on both devices, the modified data is mutually transferred as new data. When data on one device corresponding to modified data on the other device has been deleted, the modified data is transferred to the deleted side. Finally, data on the mobile terminal 1 corresponding to data that has been deleted on the PC 30 is deleted, and data on the PC 30 corresponding to data that has been deleted on the mobile terminal 1 is deleted.

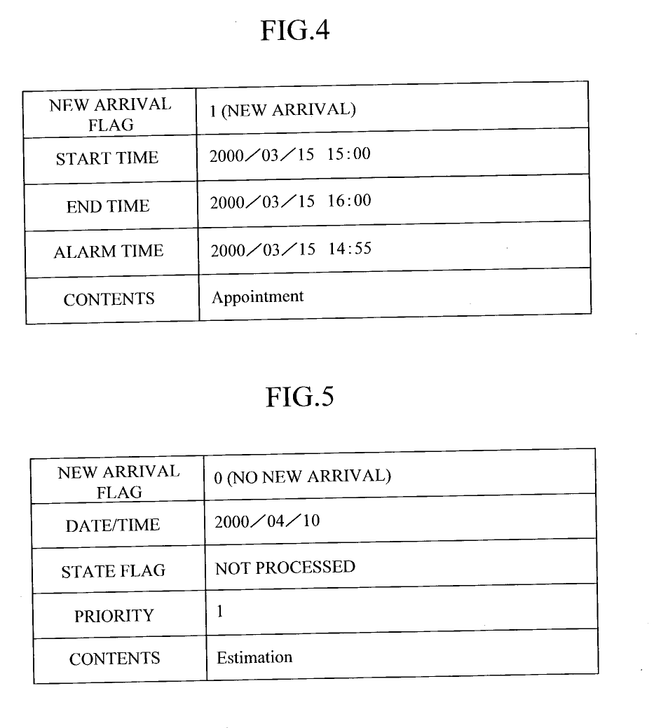

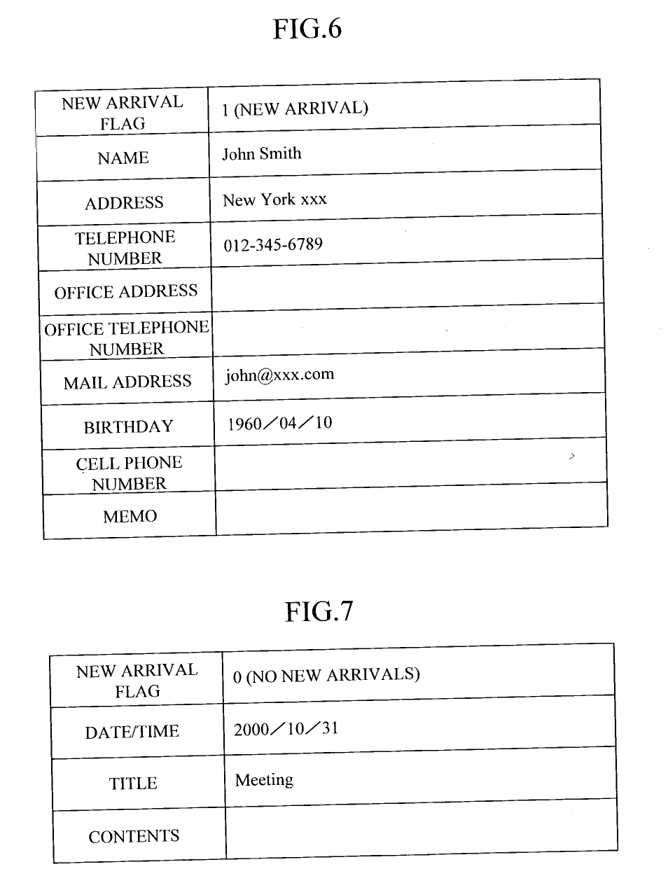

FIGS. 3 to 7 show the data structure of each application. FIG. 3 shows the data structure of email. FIG. 4 shows the data structure of a schedule. FIG. 5 shows the data structure of a to-do list. FIG. 6 shows the data structure of an address book. FIG. 7 shows the data structure of a memo book.

Although the data structure differs from one application to another, all of the above-mentioned data structures commonly include a field for a new arrival flag, the field being referred to as a common region. Thus, another application can be incorporated by modifying its data structure so that it has a common region. The data structure in the present embodiment includes a common region that commonly exists in multiple applications and an inherent region that is unique to each application. For example, during the synchronizing process, a new arrival flag is added in a common region accompanying the data for which the inherent region has been updated.

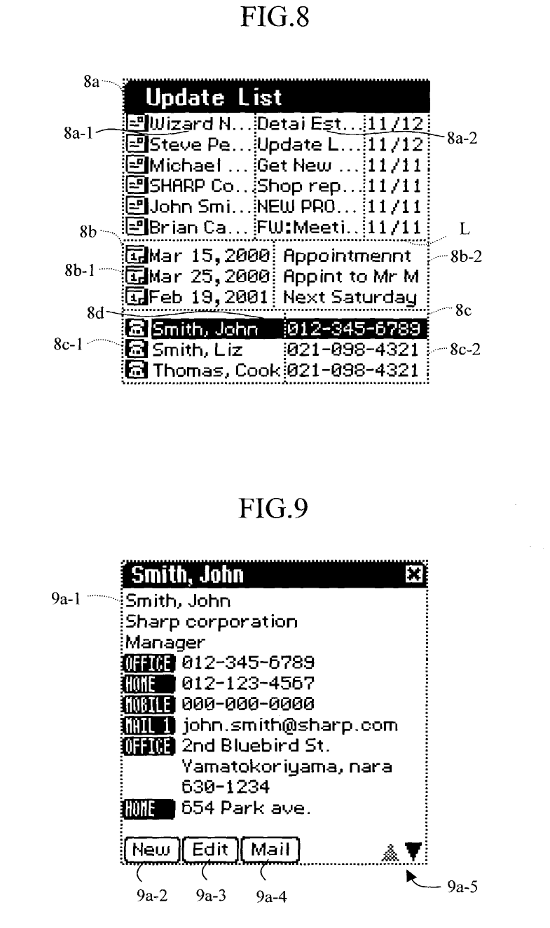

FIG. 8 shows an example of a new arrival list window. A region 8a shows a list of email data items that have newly arrived. A region 8b shows a list of schedule data items that have newly arrived. A region 8c shows a list of address book data items that have newly arrived. In this display window, by selecting a data item with up and down keys for scrolling up and down within the window, and with the execution key for executing a process, the details of the data item can be displayed. A region 8d is inverted, indicating currently selected data item. When the entirety of the data cannot be shown in a single window, the screen can be scrolled up and down with the appropriate keys, such as the ones shown in FIG. 9.

FIG. 9 shows an example of a display window showing the details of the data of FIG. 8. By selecting one item of data in the list of FIG. 8, the window can be switched to a window showing the detail of the data item.

The display window 9a-1 shown in FIG. 9 is a window showing the data of an address book. A new data generating button 9a-2, an editing button 9a-3, a mail creating button 9a-4, and a window scroll button 9a-5 are arranged at the bottom of the screen.

As shown in FIG. 3, the new arrival flag 1 indicates that the data has been updated by the synchronizing process. As shown in the region 8a of FIG. 8, the displayed list includes a sender field 8a-1 and a subject field 8a-2 of the mail.

Similarly, with regard to the data of the schedule of FIG. 4 and the data of the address book of FIG. 6, as the flag in the new arrival field is 1, a list 8b of dates 8b-1 and content 8b-2, and a list 8c of names 8c-1 and telephone numbers 8c-2 are displayed.

With regard to the data of the to-do list of FIG. 5 and the data of the memo book of FIG. 7, the flag in the new arrival field indicates 0. This indicates that the respective data items have not been updated by the synchronizing process. Thus, these data items are not included in the displayed list.

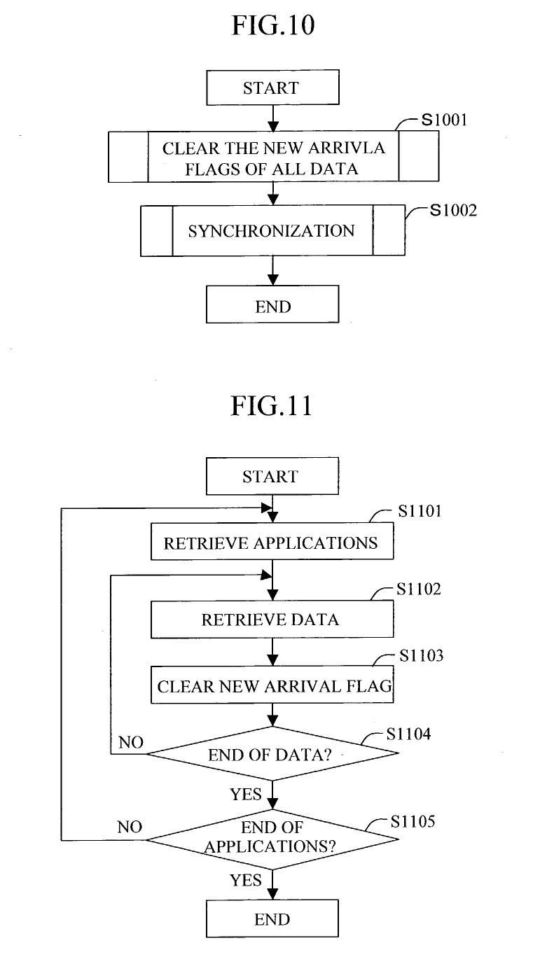

FIG. 10 shows a flowchart of the synchronizing process, which will be described by referring to FIGS. 1 and 2 as necessary.

Before the synchronizing process is initiated by the user carrying out a necessary operation, a process is performed in step S1001 to clear (or to zero) the new arrival flag for all of the data on the mobile terminal 1.

In step S1002, data is synchronized between the PC 30 and the mobile terminal 1.

The processing in step S1001 will be described in detail by referring to FIG. 11. In step S1101, applications available on the mobile terminal 1 are retrieved. In step 1102, the data in each application is retrieved. In step S1103, the new arrival flags for all of the data retrieved in step S1102 are cleared.

In steps S1104 and S1105, the above process is repeated until all of the data items in all of the applications have been processed.

As a result, the new arrival flags for all of the data are cleared.

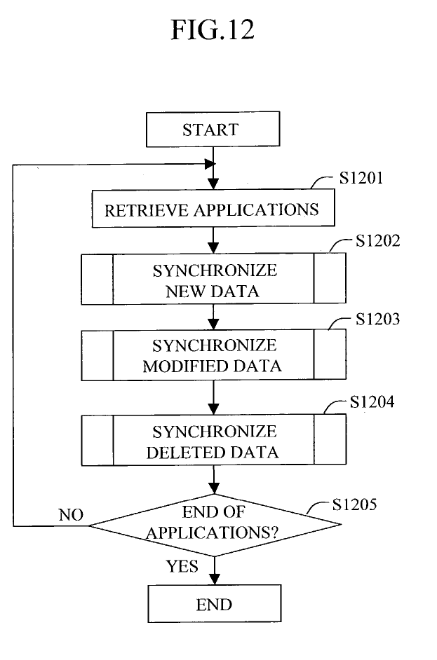

Next, the synchronizing process in step S1002 of FIG. 10 will be described by referring to FIGS. 12 to 15. Reference will also be made to FIGS. 1 and 2 as necessary.

FIG. 12 shows a flowchart of the synchronizing process. In step S1201, applications are retrieved. In steps S1202 to S1204, the synchronizing process is performed on new data, modified data, and deleted data individually for each of the retrieved applications.

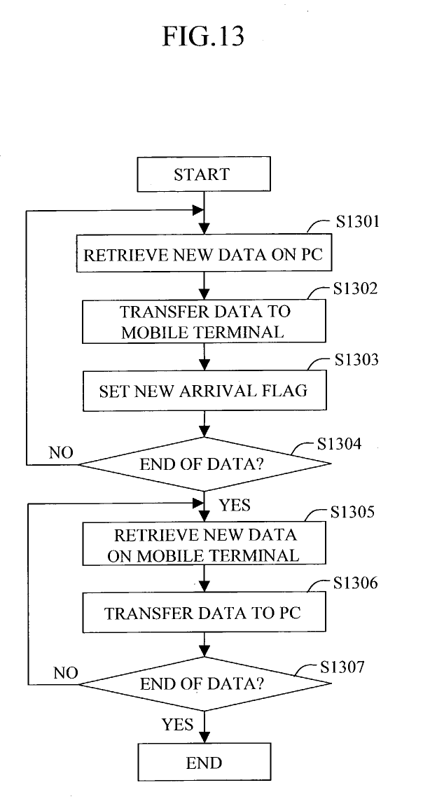

FIG. 13 shows a flowchart of the new data synchronizing process. In step S1301, a new data item on the PC 30 concerning the applications retrieved in step S1201 of FIG. 12 is retrieved. In step S1302, the retrieved data item is transferred to the mobile terminal 1. In step S1303, before the transferred data item is registered on the mobile terminal 1, the new arrival flag for that data item is set. In step S1304, the above process is repeated until there is no more new data items.

Then, in step S1305, a new data item on the mobile terminal 1 is retrieved. The retrieved data item is transferred to the PC 30 in step S1306. In step S1307, the above process is performed for all of the new data items.

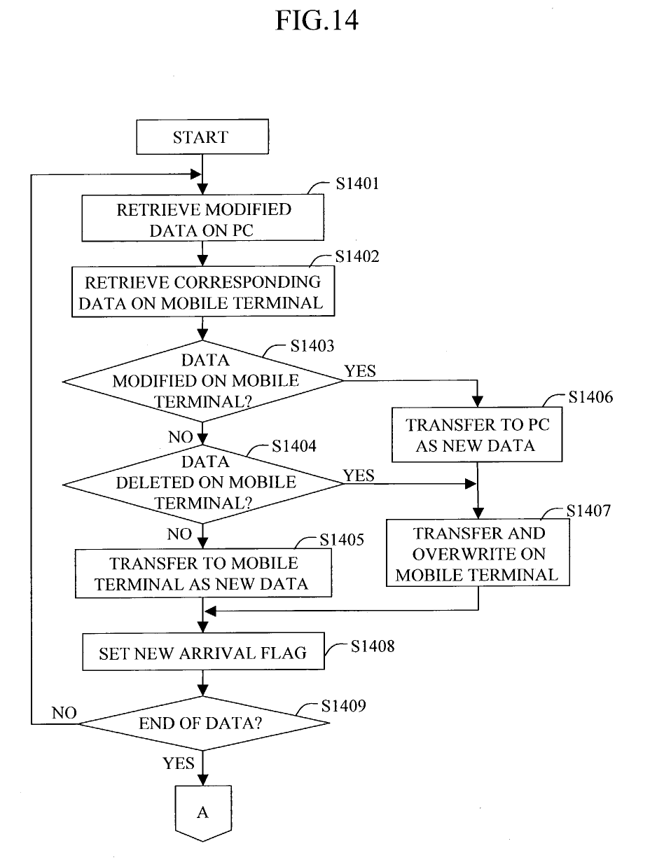

FIG. 14 shows a flowchart of the modified-data synchronizing process. In step S1401, a modified data item on the PC 30 is retrieved. In step S1402, a corresponding data item on the mobile terminal 1 is retrieved. In step S1403, it is determined whether or not the data item retrieved on the mobile terminal 1 is modified. In step S1404, it is determined whether or not the data item is deleted.

When the data item is neither modified nor deleted, the routine goes to step S1407, where the corresponding data item on the mobile terminal 1 is overwritten. When it is shown in step S1404 that the data item has been deleted on the mobile terminal 1, the modified data item on the PC 30 is transferred to the mobile terminal 1 as new data in step S1405. When it is determined in step S1403 that the data item is modified on the mobile terminal 1, the modified data item is transferred to the PC 30 as new data in step S1406, and the modified data item on the PC 30 is written over on the mobile terminal 1.

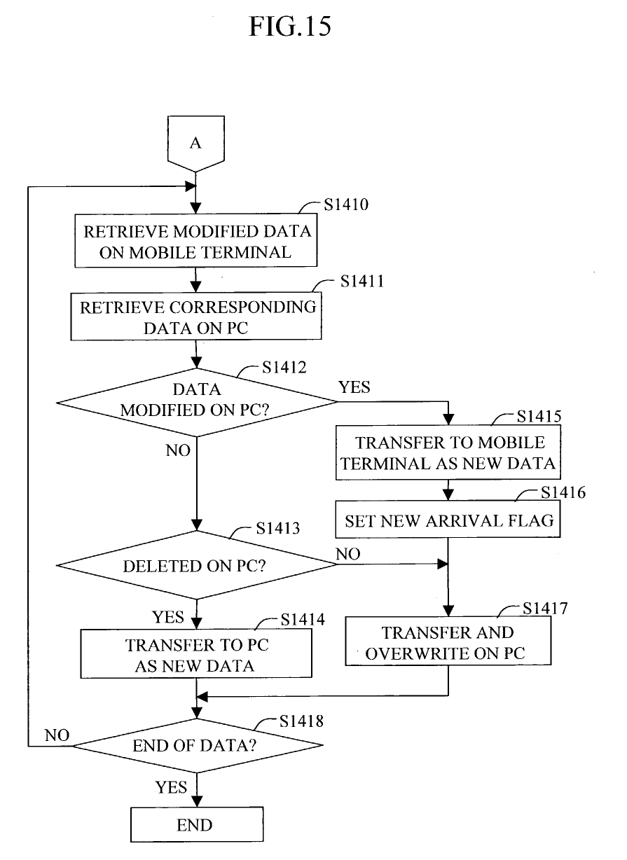

In any case, the new arrival flag for the added or modified data item is set in step S1408. In step S1409, it is determined whether the above process is complete. The routine from steps S1401 to S1408 is repeated until the process is complete. As shown in FIG. 15, in step S1410, a modified data item on the mobile terminal 1 is retrieved. In step 1411, the corresponding data item on the PC 30 is retrieved. It is then checked in step S1412 to see if the retrieved data item on the PC 30 is modified. In step S1413, it is determined whether or not the retrieved data item on the PC 30 is deleted.

When it is determined in steps S1412 and S1413 that the data item has neither been modified nor deleted, the corresponding data item on the PC 30 is overwritten in step S1417. When the corresponding data item on the PC 30 is deleted, the data on the mobile terminal 1 is transferred to the PC 30 as new data in step S1414. If the corresponding data item is modified on the PC 30, it is transferred to the mobile terminal 1 in step S1415 as new data, and the modified data on the mobile terminal 1 is written over on the PC 30. In step S1416, the new arrival flag for the added data is set. In step S1418, it is checked to see if the processing of all of the data items is complete. If not, the above process (from steps S1410 to S1418) is repeated until all of the data items have been processed.

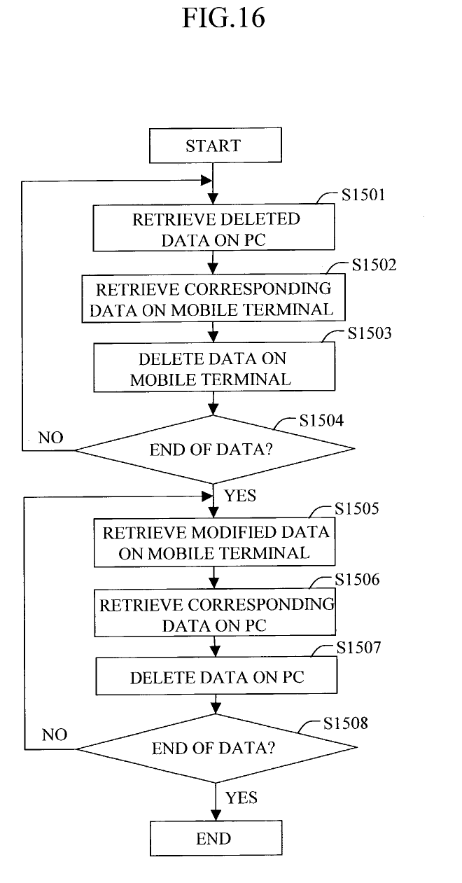

FIG. 16 shows a flowchart of the deleted data synchronizing process. In step S1501, a deleted data item on the PC 30 is retrieved. In step S1502, a corresponding data item on the mobile terminal 1 is retrieved. In step S1503, the retrieved data item on the mobile terminal 1 is deleted. In step S1504, it is determined whether or not the data processing is complete. If not, the above process (from steps S1501 to S1504) is repeated until all of the data items have been processed.

On the other hand, in step S1505, a deleted data item on the mobile terminal 1 is retrieved. In step S1506, a corresponding data item on the PC 30 is retrieved. In step S1507, the retrieved data item on the PC 30 is deleted. It is then determined in step S1508 whether or not the above routine is completed. If not, the routine (from steps S1505 to S1508) is repeated until all of the data items have been processed.

When the synchronizing process is complete, a new arrival flag will have been set for each of the data items that have been added or modified during the synchronizing process.

For example, with regard to the data added or modified by the synchronizing process, the new arrival flag is set to 1, as in the mail data of FIG. 3, the schedule data of FIG. 4 and the address-book data of FIG. 6.

In the data that had existed on the mobile terminal 30 before the synchronizing process was performed (i.e., the data that has not been modified, for example), the new arrival flag is 0 as it is cleared in step S1001 (FIGS. 10 and 11), as in the to-do list data of FIG. 5 and the memo book data of FIG. 7.

While the new arrival flags for all of the data items are cleared at once in step S1001 prior to synchronization, the clearing may take place when detailed contents are confirmed or when the new arrival list is displayed.

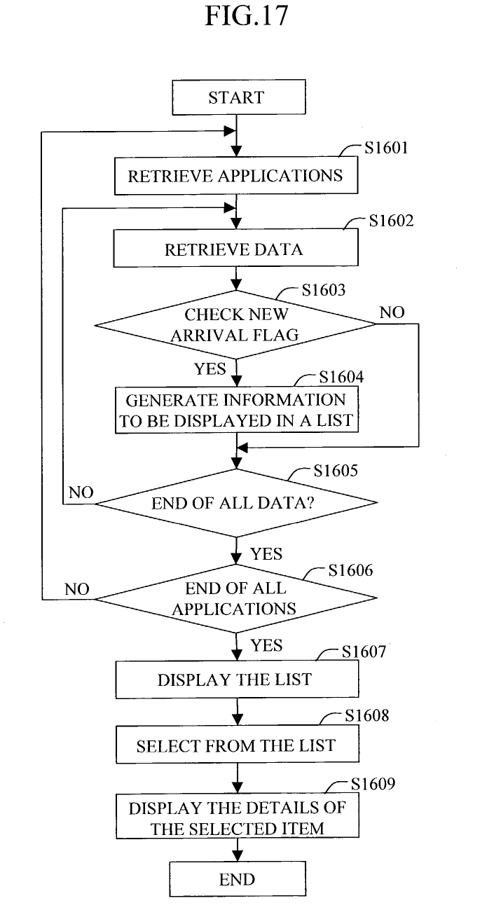

FIG. 17 shows a flowchart of the process of creating a new arrival list and displaying data. In step S1601, applications are retrieved, and the following process is performed on each application. A data item of the retrieved application is retrieved in step S1602. In step S1603, it is determined whether or not a new arrival flag is set for the data item. If it is set, the routine goes to step S1604, where information to be displayed in a list for the application is generated. For example, when the mail data is retrieved and the data item as shown in FIG. 3 is read, list information is generated using that data item as new data because the new arrival flag is set to 1. When the data item of FIG. 5 is read during the retrieving of the to-do list data, the data item is not added to the new arrival list because the new arrival flag is 0.

When the new arrival flag is not set, the routine goes to step S11605, where it is determined whether or not all of the data items have been checked. If not, the routine returns to step S1602, and the above process is repeated until all of the data items have been checked. In step S1606, the above process is repeated for all of the applications. In step S1607, the generated list information is displayed on the screen. As shown in FIG. 8, demarcation lines L are provided at the boundaries between the individual applications and fields for improving clarity.

In step S1608, the user selects an item of data from the displayed list for which he wishes to see detailed information. The details of the selected data item are displayed in step S1609. As mentioned above, the region 8d is selected in FIG. 8. By operating the execution key, the screen of FIG. 8 can be switched to the details screen of FIG. 9.

Alternatively, in step S1605, a list may be displayed when the maximum number of items of data that can be displayed within the screen has been processed, before waiting until the end of the processing of all of the data items is confirmed. The subsequent retrieval process may be resumed upon demand by the user.

Thus, by displaying the new arrival list of only those items of data that have been added or modified by the synchronizing process, the user can immediately grasp which data item has been updated. The details regarding a certain data item can be easily displayed by selecting the data item.

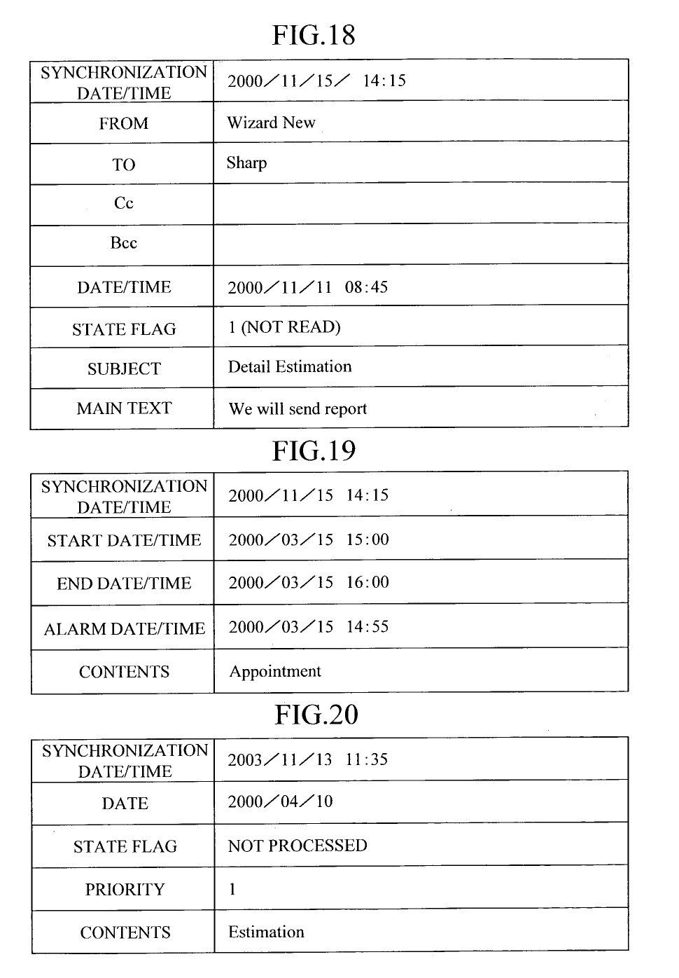

Hereafter, a new arrival information display technique according to a second embodiment will be described by referring to FIGS. 18 to 24.

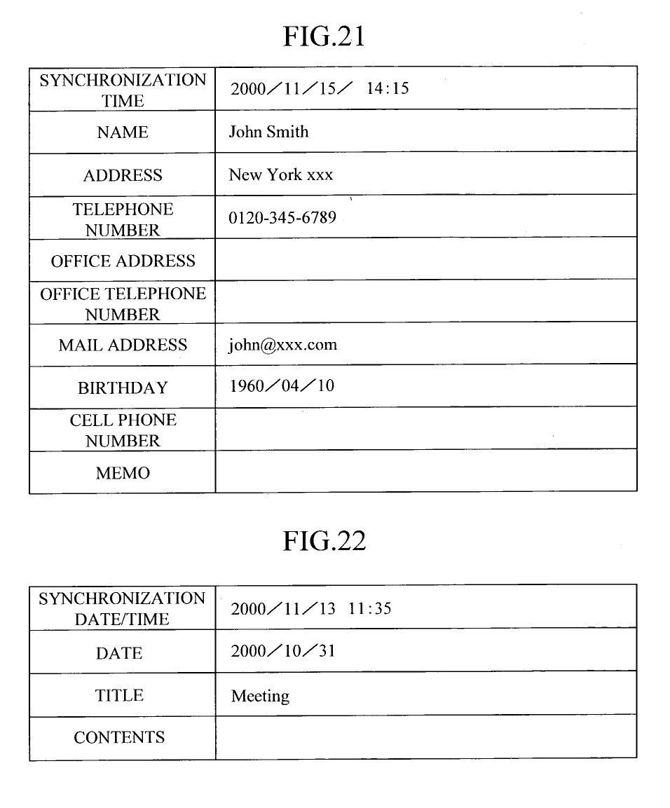

FIGS. 18 to 22 show the data structure of each of the applications relating to the new arrival information display technique according to the second embodiment. FIG. 18 shows the data structure of email. FIG. 19 shows the data structure of a schedule. FIG. 20 shows the data structure of a to-do list. FIG. 21 shows the data structure of an address book. FIG. 22 shows the data structure of a memo book.

Although the data structure differs from one application to another, the applications commonly have a synchronization date/time field. When another application is to be added, its data structure is adapted such that it also has a synchronization date/time field.

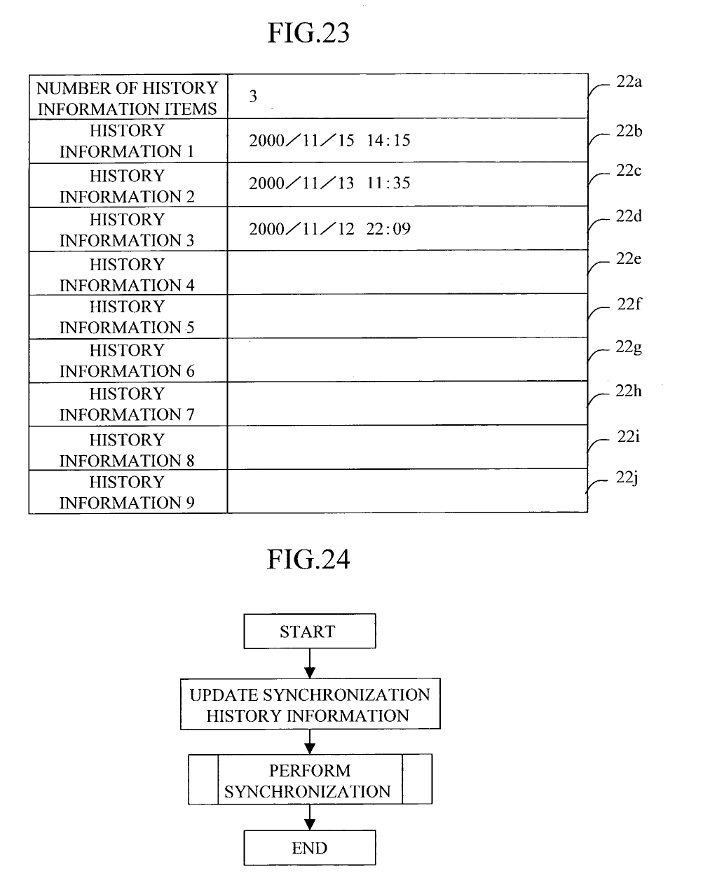

FIG. 23 shows the data structure of the synchronization history information. The data structure includes a region 22a indicating how many items of history information are stored in the history information memory region, and regions 22b to 22j. The regions 22b to 22j store synchronization history information, which indicates the date/time when the synchronization process was performed. Each time the synchronization process is performed, the information in the region 22j is deleted, and the information in each of the regions 22b to 22i is shifted down to a field immediately below. Thus, the latest synchronization data/time is recorded in the field 22b.

In the example of FIG. 23, synchronization history information about three instances of synchronization is recorded in regions 22b to 22d. Thus, the number of items of history information in the region 22a is 3. The history information 1 in the region 22b reads: “2000/11/15 14:15.” Thus, the email data of FIG. 18, the schedule data of FIG. 19, and the address-book data of FIG. 21, in which the information “2000/11/15 14:15” is written in the synchronization date/time field, can be identified as having been updated by the latest synchronizing process. A list of these data items is displayed, as shown in FIG. 8.

The content of the synchronization date/time field in the to-do list of FIG. 20 and the memo book of FIG. 22, respectively, corresponds to the history information 2 in the region 22c of FIG. 23. Thus, it can be seen that these data items have been updated by the second to last synchronizing process.

FIG. 24 shows a flowchart of an actual synchronization process. Before initiating the synchronizing process in response to a user's operation, the date/time when the synchronizing process is started is stored in the synchronization history information memory region in step S2301. In step S2302, synchronization is actually carried out. The details of the synchronizing process in this step are the same as those of FIGS. 12 to 16, except that instead of the process of setting the new arrival flag in steps S1303 of FIG. 13, and S1408 and S1416 of FIG. 14, the date/time when a synchronizing process is performed is registered in a synchronization date/time field.

As a result, when the synchronizing process is completed, the date/time information about a performed synchronizing process will have been updated with regard to the data added or modified by the synchronizing process.

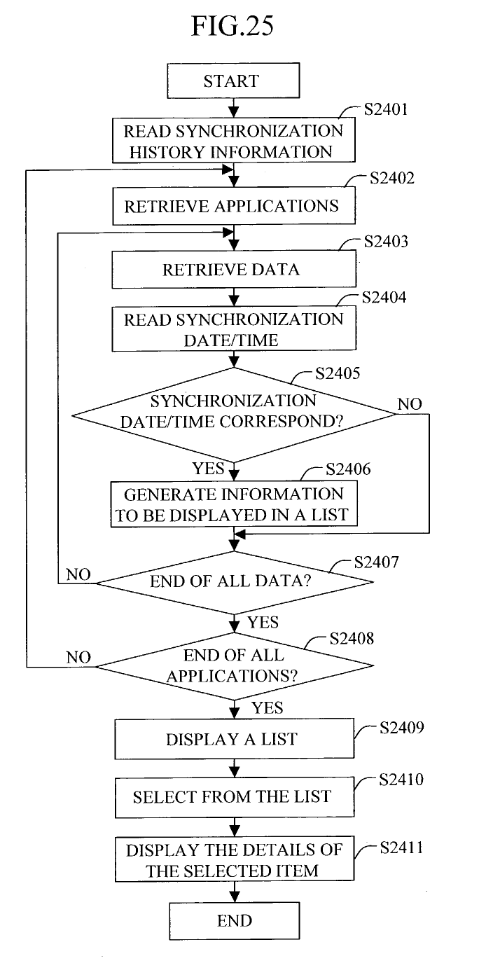

FIG. 25 shows a flowchart of the process of displaying data after creating a new arrival list. In step S2401, the latest date/time when synchronization was performed is read from the synchronization history information. In step S2402, applications are retrieved, and the following process is performed on each of the applications. In step S2403, a data item for an application is retrieved. In step S2404, the synchronization date/time of the data item on the mobile terminal 1 (FIGS. 1 and 2) is read. In step S2405, the synchronization date/time of the data on the mobile terminal 1 is compared with the latest date/time of synchronization read from the synchronization information.

If the individual date/times of synchronization correspond, information to be displayed in a list for the particular application is generated in step S2406. In step S2407, it is then confirmed whether or not all of the data items have been processed. If not, the routine returns to step S2403, and the above process is repeated until it is confirmed that all of the data items have been processed.

In step S2408, the above process is repeated for all of the applications. In step S2409, the generated list information is displayed on the window. In step S2410, the user selects a data item from the displayed list for which he wishes to see the details. In step S2411, the details of the selected item of data can be displayed.

The list-display condition in step S2405 may also include whether or not there is data corresponding to the nth to last synchronization date/time, or whether there is data that has been updated within n hours of the current time by synchronization, in addition to correspondence with the latest synchronization date/time.

In step S2407, instead of waiting until all of the data is confirmed, a list may be displayed when the maximum number of data items for display in a single screen has been processed. In this case, subsequent data items can be processed upon instruction by the user.

Thus, a new arrival list of only those data items that have been added or modified by the synchronizing process can be displayed on the screen. The user can easily grasp which data items have been updated by looking at the displayed list, and he or she can further see the details of a data item of interest by selecting and displaying that data item.

In the present embodiment, data attribute information other than the date/time information may be used.

Many modifications and variations of the present invention are possible in the light of the above teachings. It is therefore to be understood that within the scope of the appended claims, the invention may be practiced otherwise than as specifically described.

For example, the technique according to the invention may also be applied to synchronization between mobile terminals or between PCs, instead of between a mobile terminal and a PC. The synchronizing technique may also utilize wireless communication.

Thus, in accordance with the invention, after synchronizing data among a plurality of information processing devices running a plurality of different applications, the user can easily grasp on one information processing device which data item or items have been updated. Details regarding a data item can be easily selected and displayed.

Accordingly, the user can check the outline and content of new data items preferentially, thus reducing the time and energy necessary for confirmation of new arrival data.

What is claimed is:

1. An information processing apparatus capable of operating a plurality of applications, comprising:
means for attaching an identification marker to an item of data in multiple applications that has been updated by a process;
means for storing data items including the data item having the identification marker; and
means for retrieving the updated data from the data items based on the identification marker.

2. The information processing apparatus according to claim 1, further comprising means for displaying a list of updated data items retrieved by the updated data retrieval means.

3. The information processing apparatus according to claim 1 or 2, wherein the identification marker includes flag information, date/time information, and data attribute information.

4. A method of controlling an information processing apparatus capable of operating a plurality of applications, comprising the steps of:
attaching an identification marker to an item of data that has been updated by a process;
storing data items including the data item having the identification marker; and
retrieving the updated data from the data items based on the identification marker.

5. A program operated on an information processing apparatus capable of operating a plurality of applications, the program comprising routines for:
attaching an identification marker to an item of data that has been updated by a process;
storing data items including the data item having the identification marker; and
retrieving the updated data from the data items based on the identification marker.

6. A first information processing apparatus comprising means for displaying a plurality of different data items for a plurality of applications, the apparatus further comprising:
means for attaching identification marker to a data item in the data for the multiple applications in the first information processing apparatus that has been updated by a synchronizing process between the first information processing apparatus and a second information processing apparatus;
means for storing data items including the updated data having the identification marker; and
means for retrieving the updated data from the data items based on the identification marker.

7. The first information processing apparatus according to claim 6, further comprising:
means for controlling the display of a list of data items for the multiple applications retrieved by the data retrieval means;
means for selecting at least one data item from the displayed list of data items; and
means for controlling the display of the details of the data item selected by the selection means.

8. A first information processing apparatus comprising means for displaying a plurality of different items of data for a plurality of applications, the apparatus further comprising:
means for storing first information about the date/time when a data item in the multiple applications on the first information processing apparatus has been updated by a synchronizing process between the first information processing apparatus and a second information processing apparatus, in association with the updated data item;
means for storing second information about the history of synchronization, whereby the date/time is recorded each time a synchronizing process is performed;
means for comparing the first and second information; and
means for retrieving an item of data stored in the memory means that is associated with the first information which corresponds to the second information.

9. The first information processing apparatus according to claim 8, further comprising:
means for controlling the display of a list of data items for the multiple applications retrieved by the data retrieval means;
means for selecting at least one item of data from the displayed list; and
means for displaying the details of the selected data item.

10. A data structure comprising identification information for identifying data that has been updated by a synchronizing process between information processing apparatuses, the structure further comprising a data region common to multiple applications.

11. A method of displaying information in a first information processing apparatus comprising means for displaying a group of data items for each of a plurality of applications, the method comprising the steps of:
storing the fact that data has been updated by a synchronizing process between the first information processing apparatus and a second information processing apparatus;
retrieving the data item updated by synchronization;
displaying a list of retrieved data items for the multiple applications;
selecting an item of data from the displayed list; and
displaying the details of the selected data.

12. A method of displaying information in a first information processing apparatus comprising means for displaying a group of data items for each of a plurality of applications, the method comprising the steps of:
storing first information about the date/time when an item of data is updated by a synchronizing process between the first information processing apparatus and a second information processing apparatus;
storing second information about the history of synchronization, whereby the date/time is recorded each time a synchronizing process is performed;
comparing the first and second information; and
determining whether the data has been updated by the latest synchronizing process.
